(19) United States
(12) Patent Application Publication
(10) Pub. No.: US 2013/0186718 A1
(43) Pub. Date: Jul. 25, 2013

(54) BRAKE CYLINDER STROKE ADJUSTMENT DEVICE

(71) Applicant: VALE S.A., Centro (BR)

(72) Inventors: Herlei Tafarel Junio TIBURCIO, Praia Itabira (BR); Felipe Leles Vidal De Freitas, Jardim Panorama (BR); Jeaneivision Thiago De Sousa, Recanto Verde (BR)

(73) Assignee: VALE S.A., Centro (BR)

(21) Appl. No.: 13/745,525

(22) Filed: Jan. 18, 2013

(30) Foreign Application Priority Data
Jan. 19, 2012 (BR) PI 102012001289-8

(51) Int. Cl. F16D 65/42

(52) U.S. Cl. CPC F16D 65/42
USPC 188/197

(57) ABSTRACT

A device for adjusting the stroke of a brake cylinder has an elongated body endowed with a first end associated to a gap adjuster and a second end endowed with a flat structure which has a plurality of regulators. The regulators are disposed such that distances between centers of these regulators correspond to pre-determined adjustments to the stroke of the brake cylinder.

The present invention refers to a brake cylinder stroke adjustment device, particularly to a rod applied to adjust the brake cylinder of trains, this device being endowed with orifices which facilitate regulation of the brake cylinder stroke.

### DESCRIPTION OF THE STATE OF THE ART

With the need for adjusting the stroke of brake cylinders of trains, rod-type devices have been created as a means of carrying out this regulation. Thus, the train cars are submitted to brake tests and, if an incorrect brake cylinder stroke is detected, it is necessary to adjust the stroke of this cylinder and, accordingly, a rod device has been used.

This unique rod in the braking system is usually kept threaded in a component called a cane next to the brake system and associated to the gap adjuster, such that when it is necessary to adjust the brake cylinder stroke, it is necessary to release the locknut of the cane and a counter-pin fastening the rod.

The cylinder stroke is regulated by way of the thread contained on the rod, however, the thread disposed on the rod is constantly oxidized, contaminated and damaged, requiring, as a rule, the replacement of this rod in order to carry out regulation.

In this sense, prominence is given to document MU 7702590-3 which, although disclosing a rod for mechanical adjustment of gaps in brakes of rail cars for advantageously regulating the brake cylinder stroke of trains, it is still difficult to drive the rod due to jamming thereof by oxidation.

### OBJECTIVES OF THE INVENTION

Therefore, an objective of the present invention is to provide a device for adjusting the brake cylinder stroke for trains endowed with regulating means which allow the adjustments to be made quickly and practically.

Another objective of the present invention is to provide a device for adjusting a brake cylinder stroke for trains that does not jam due to oxidation and other weather exposure.

### BRIEF DESCRIPTION OF THE INVENTION

The object of the invention is a device for adjusting the brake cylinder stroke, comprising an elongated body endowed with a first end associated to a gap adjuster and a second end endowed with a flat structure which comprises a plurality of regulating means, the regulating means being disposed such that the distances between centers of these regulating means correspond to pre-determined adjustments to the brake cylinder stroke.

### BRIEF DESCRIPTION OF THE DRAWINGS

The present invention shall now be disclosed in greater detail based on an example of execution represented in the drawings. The drawings show:

FIG. 1—is a front cut-off view of the device for adjusting the brake cylinder stroke which is the object of this invention;

FIG. 2—is a side view of the device for adjusting the brake cylinder stroke which is the object of this invention; and

Photograph 1—depicts the device for adjusting the brake cylinder stroke which is the object of this invention positioned on a train.

### DETAILED DESCRIPTION OF THE DRAWINGS

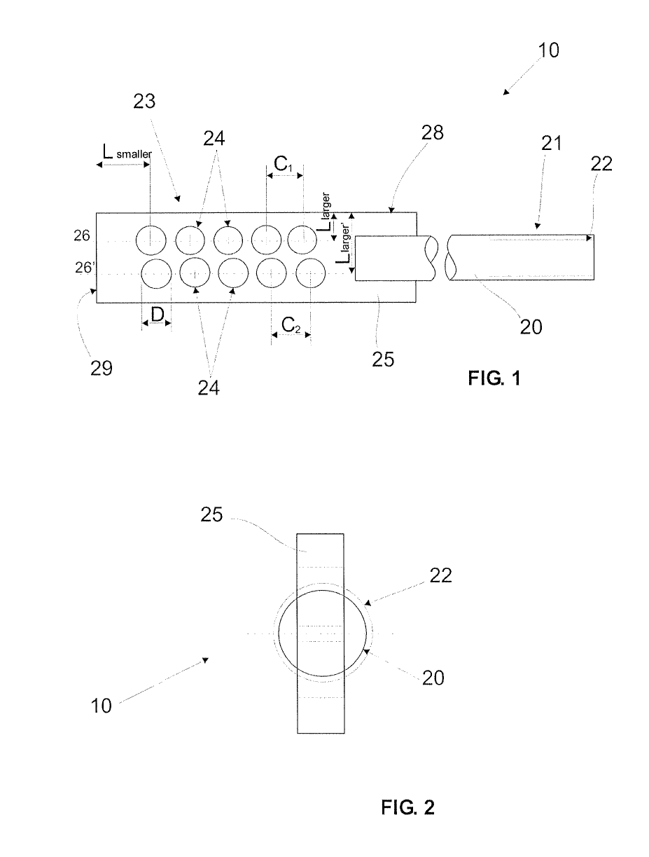

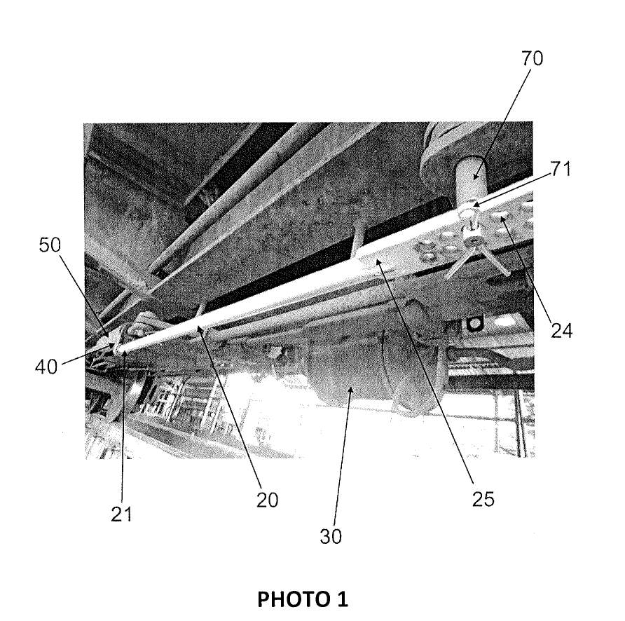

According to a preferred embodiment and as can be seen in FIGS. 1 and 2 and photograph 1, the device for adjusting the stroke 10 of a brake cylinder 30, which is the object of this invention, consists of a rod 10 endowed with an elongated body 20 having a preferably cylindrical section, or shaped otherwise.

The elongated body 20 comprises a first end 21 endowed with a means of fastening 22 the rod 10 in the gap adjuster 50 mounted on the rear part of the train, this fastening means 22 preferably consisting of a thread conceived on the elongated body 20, whose function is solely to fasten the rod 10 to the cane 40 for mounting on the gap adjuster 50, however, other fastening means can be used such as, for example, interference fit, pin or clip fit, screws, among others.

Further, the elongated body 20 comprises a second end 23 endowed with a flat structure 25, which comprises a plurality of regulating means 24. The flat structure 25 presents a preferably rectangular section and is associated to the elongated body 20 by welding, gluing or other equivalent means.

The regulating means consist of a plurality of through orifices 24, disposed on the flat structure 25 in pre-determined positions and responsible for the adjustments to the brake cylinders 30.

In this sense, these orifices 24 comprise the same diameter D and are positioned on the flat structure 25 so as to form at least two lines 26, 26′ of orifices 24 parallel to each other. The orifices 24 of a same line 26, 26′ are equidistant to each other, meaning that the distance between centers C₁ of the orifices 24 disposed on the first line 26 are identical to each other, as is the distance between centers C₂ of the orifices 24 disposed on the second line 26′. The distances between centers C₁ and C₂ may or may not be identical, depending on the adjustment attributed to this rod 10.

Additionally, the disposition of the orifices 24 on the flat structure 25 is also made respecting a larger side constant distance L_{larger}, which consists of the distance from the centers of the orifices 24 lined in relation to a larger edge 28 of the flat structure 25 and a greater side distance lateral Lₛₘₐₗₗₑᵣ equivalent to the distance from the centers of the orifices 24 lined in relation to the smaller edge 29 of the flat structure 25.

Particularly, the first and second lines 26, 26′ comprise larger constant distances L_{larger}, L_{larger}, and these larger side distances L_{larger}, L_{larger}, consist of the distance from the centers of the orifices 24 aligned on the first and second lines 26, 26′ in relation to the larger edge 28 of the flat structure 25.

The larger side distance Lₛₘₐₗₗₑᵣ particularly consists of the distance between the centers of the devices 24 disposed on the first and second lines 26, 26′ and the smaller edge 29 of the flat structure 25, such that for the first orifices 24 near the smaller edge 29 this distance is equal to the space existing from the smaller edge 29 to the centers of the first orifices 24. For the other orifices 24 aligned to the first and equidistant thereto, this smaller side distance Lₛₘₐₗₗₑᵣ consists of the first space measured added to the distance between centers C₁ or C₂, in other words Lₛₘₐₗₗₑᵣ+nC₁ or Lₛₘₐₗₗₑᵣ+nC₂, where n is the quantity of orifices 24 after the first one.

However, it must be emphasized that lines 26, 26′ of orifices 24, though parallel, do not comprise orifices 24 aligned in parallel, in other words, the orifices 24 are aligned in lines 26, 26′, however, the center of an orifice 24 of the first line 26 is not necessarily aligned to the center of the orifice 24 of the second line 26′. Accordingly, the positioning of the orifices 24 on the flat structure 25 is done based on the necessary adjustments to the stroke of the brake cylinder 50 of the train, attributing greater versatility to the rod 10 which is the object of this invention.

As can be seen in photograph 1, when mounted on the train, a rod 10 comprises its first end 21 of the elongated body 20 associated to a cane 40 of the gap adjuster 50 and at least one orifice 24 of the flat structure 25 associated to at least a shaft 70 passing perpendicularly through the orifice 24 and fastened by a clip 71. Accordingly, the rod 10 is kept parallel to the longitudinal shaft of the train and parallel to the displacement tracks of this composition.

The brake cylinder stroke 30 is adjusted by the orifices 24, since each orifice 24 corresponds to a distance for adjusting the cylinder stroke. This means that the distance between centers C₁ and C₂ of the orifices corresponds to adjustments of ½ inch in the stroke of the brake cylinder 30. Thus, the fastening means 22 keeps the rod 10 fastened to the cane 40 of the gap adjuster 50 such that, when verifying the need for adjustment to the stroke of this brake cylinder 30, the clip 71 is withdrawn, the flat structure 25 is disengaged from the shaft 70 by withdrawing the shaft 70 from the original orifice 24 and replacing the shaft 70 through another orifice 24 which may be from any one of the lines of orifices 26 and 26′ and, further, the orifice 24 may or may not be consecutive, depending on the adjustment stroke required by the brake cylinder 30.

Once the through shaft 70 is suitably positioned in the orifice 24, the clip 71 is replaced fastening the rod 10 and maintaining the stroke of the adjusted brake cylinder 30.

Accordingly, there is no need to use thread to adjust the stroke of the brake cylinder 50, which avoids jamming thereof by weather exposure. Further, the distance between centers C₁ or C₂ of the orifices 24 corresponds to four turns of the thread used thus far and known in the state of the art for the adjustment of ½ inch to the stroke of the brake cylinder 30. Hence, the device 10 which is the object of this invention can be used in various brake models of diverse types of trains.

With the orifices 24 the adjustment of the stroke of the brake cylinder 30 is made with greater accuracy, practicality and safety, enhancing the reliability of the component, since in the rods known to-date this adjustment is carried out by thread, which very easily jams under the action of corrosion and contamination of the products transported, it being necessary to replace the rod and scrap it.

In the device 10 that is the object of this invention, the fastening means 22 which preferably consists of a thread, is only used to fasten the rod 10 next to the cane 40, the adjustment of the stroke of the brake cylinder 30, as already described, is carried out by changing the position of the orifices 24 which are not subject to jamming due to corrosion, further guaranteeing useful life to the device 10.

Having described one example of a preferred embodiment, it should be understood that the scope of the present invention encompasses other possible variations, being limited solely by the content of the accompanying claims, potential equivalents included therein.

1. A device for adjusting the stroke (10) of a brake cylinder (30), characterized by comprising
an elongated body (20) endowed with a first end (21) associated to a gap adjuster (50) and a second end (23) endowed with a flat structure (25) which comprises a plurality of regulating means (24),
the regulating means (24) being disposed such that distances between centers (C₁ and C₂) of these regulating means (24) correspond to pre-determined adjustments in the stroke of the brake cylinder (30).

2. A device, as claimed in claim 1, characterized by the fact that the regulating means (24) consist of through orifices, associable to a shaft (70) perpendicularly through at least one orifice (24), the shaft (70) being fastened to a structure of a train.

3. A device, as claimed in claim 2, characterized by the fact that the orifices (24) are disposed on the flat structure (25), equidistant, forming at least a first and a second lines (26, 26′) parallel to each other.

4. A device, as claimed in claim 2, characterized by the fact that
the distances between centers (C₁) of the orifices (24) disposed on the first line (26) are identical, and
the distances between centers (C₂) of the orifices (24) disposed on the second line (26′) are identical.

5. A device, as claimed in claim 2, characterized by the fact that the orifices (24) are disposed on the flat structure (25) such that the first and second lines (26, 26′) comprise larger side constant distances (L_{larger}, L_{larger′}), the larger side distances (L_{larger}, L_{larger′}) consisting of the distance from the centers of the orifices (24) aligned on the first and second lines (26, 26′) in relation to a larger edge (28) of the flat structure (25).

6. A device, as claimed in claim 2, characterized by the fact that the orifices (24) are disposed on the flat structure (25) so as to comprise a smaller side distance (Lₛₘₐₗₗₑᵣ) between its centers and a smaller edge (29) of the flat structure (25).

7. A device, as claimed in claim 1, characterized by the fact that a first end (21) of the elongated body (20) is associated to the brake cylinder (50) through a fastening means (22).

8. A device, as claimed in claim 7, characterized by the fact that the fastening means (22) is associated to a cane (40) of the gap adjuster (50).

9. A device, as claimed in claim 8, characterized by the fact that the fastening means (22) of the first end (21) of the elongated body (20) consists of a thread.
